(19) United States
(12) Patent Application Publication
(10) Pub. No.: US 2021/0339160 A1
(43) Pub. Date: Nov. 4, 2021

(54) SUSTAINABLE SYSTEMS AND METHODS FOR BUBBLE SOLUTIONS

(71) Applicant: American Bubble Company, Los Angeles, CA (US)

(72) Inventors: Susan Wasserman, Los Angeles, CA (US); Geoffrey Wasserman, Los Angeles, CA (US); Robert Joseph Ivanic, Santa Clarita, CA (US)

(21) Appl. No.: 17/104,707

(22) Filed: Nov. 25, 2020

Related U.S. Application Data
(60) Provisional application No. 63/019,110, filed on May 1, 2020.

(51) Int. Cl. A63H 33/28; B65D 25/42; B65D 77/04

(52) U.S. Cl. CPC A63H 33/28; B65D 77/0426; B65D 25/42

(57) ABSTRACT

Disclosed herein are sustainable (reusable, refillable, and recyclable) systems and methods for bubble solutions, which in various embodiments may comprise a bubble box/container/carton (recyclable), a refill bubble bag with spout (recyclable), a bubble bottle (refillable and reusable) including a bottle neck and a tamper-evident bottle cap with bubble wand (either attached to the cap or non-attached), and a liquid bubble solution/concentrate (environmentally friendly).

### CROSS-REFERENCE TO RELATED APPLICATIONS

This application claims the benefit of U.S. Provisional Application No. 63/019,110, filed May 1, 2020, which is incorporated by reference herein in its entirety.

### BACKGROUND

Bubble blowing products generally comprise a bottle filled with bubble solution, and a wand. The bottle and wand are plastic.

### SUMMARY

Various embodiments of the present invention provide sustainable (reusable, refillable, and recyclable) systems and methods for bubble solutions.

In some embodiments, bubble systems of the present invention comprise a box or carton that holds and stores liquid bubble solution or concentrate in a refill bubble bag, and contains a storage compartment that holds and stores one or more aluminum/steel bubble bottles. Aluminum/steel bottles are found in various industries (e.g., for aerosol sprays), but have not been used/configured for use with bubble solution in a refill system/kit as disclosed herein.

Bubble systems according to embodiments of the present invention are configured to be refilled and reused multiple times, thereby creating less waste compared to existing bubble products and providing an easy, smart, and economical refill format for the end user.

Bubble systems according to embodiments of the present invention can be manufactured in the country of sale (e.g., made in USA).

In some embodiments, the invention provides a sustainable refill bubble system, comprising: a box having two compartments therein; a refill bag configured to fit inside a first compartment of the box; one or more bubble bottles configured to fit inside a second compartment of the box; and a liquid bubble solution or concentrate provided inside the refill bag, wherein the refill bag includes a tap for dispensing the liquid bubble solution or concentrate.

In some embodiments, at least one of the box, the refill bag, and the one or more bubble bottles comprise a recyclable material.

In some embodiments, the box comprises a corrugated cardboard material.

In some embodiments, the box is formed from a single piece of material, said piece including a partition section for separating the two compartments.

In some embodiments, a front side of the box includes a window for viewing the one or more bubble bottles on a retail shelf.

In some embodiments, a back side of the box includes a first perforated portion configured to provide a carry handle.

In some embodiments, a back side of the box includes a second perforated portion configured to provide an opening for the tap.

In some embodiments, each compartment of the box has a top flap.

In some embodiments, the tap has an automatic shut-off valve for controlled dispensing.

In some embodiments, the one or more bottles have an aluminum body.

In some embodiments, the one or more bottles include a plastic or aluminum bottle neck press-fit or snap-fit to a rolled edge/curl of the aluminum body.

In some embodiments, the one or more bottles include a plastic or aluminum screw cap with tamper-evident ring configured to screw onto the plastic or aluminum bottle neck.

In some embodiments, the one or more bottles include a plastic bubble wand secured to an inner surface of the screw cap.

In some embodiments, the one or more bottles include a plastic bubble wand not attached the screw cap.

In some embodiments, the liquid bubble solution or concentrate is environmentally friendly and non-toxic.

In some embodiments, the liquid bubble solution or concentrate is paraben free, formaldehyde donor free, NPE (nonylphenol ethoxylate) free, sulfate free, phthalate free, and/or DEA (diethanolamine) free.

In some embodiments, the refill bag has a delta seal on one or more corners thereof

In some embodiments, the invention provides a method of reducing waste associated with bubble blowing, comprising: providing a bubble box comprising a single piece of corrugated cardboard, the box having two compartments therein, separated by a partition; providing a refill bubble bag configured to fit inside a first compartment of the box, the bag containing a liquid bubble solution or concentrate; and providing one or more refillable, reusable, and recyclable bubble bottles configured to fit inside a second compartment of the box, wherein the bag includes a tap accessible from outside the box for dispensing the liquid bubble solution or concentrate into the one or more bottles.

In some embodiments, the one or more bubble bottles comprise aluminum or steel.

Additional features and advantages of the present invention are described further below. This summary section is meant merely to illustrate certain features of embodiments of the invention, and is not meant to limit the scope of the invention in any way. The failure to discuss a specific feature or embodiment of the invention, or the inclusion of one or more features in this summary section, should not be construed to limit the invention as claimed.

### BRIEF DESCRIPTION OF THE DRAWINGS

The foregoing summary, as well as the following detailed description of certain embodiments of the application, will be better understood when read in conjunction with the appended drawings. For the purposes of illustrating the systems and methods of the present application, there are shown in the drawings preferred embodiments. It should be understood, however, that the application is not limited to the precise arrangements and instrumentalities shown. In the drawings:

FIGS. 1-9 show illustrative features of a bubble box/container/carton, according to various embodiments of the invention;

FIGS. 10-11 show illustrative features of a refill bubble bag with tap/spout, according to various embodiments of the invention;

FIGS. 12-14 show illustrative features of a bubble bottle cap with tamper-evident ring, according to various embodiments of the invention;

FIGS. 15-16 show illustrative features of a bubble bottle body, according to various embodiments of the invention;

FIGS. 17-18 show illustrative features of a bubble bottle cap and wand, according to various embodiments of the invention;

FIG. 19 shows an illustrative bubble bottle body, neck and cap, according to various embodiments of the invention; and

FIGS. 20-22 show an illustrative bubble bottle body with neck, cap and attached wand, according to various embodiments of the invention;

FIG. 23 shows an assembled bubble bottle, according to various embodiments of the invention;

FIG. 24 shows an illustrative bubble body with neck, cap, and non-attached wand, according to various embodiments of the invention;

FIGS. 25-27 show illustrative features of a bubble bottle cap, according to various embodiments of the invention;

FIG. 28 shows illustrative features of a bubble bottle neck, according to various embodiments of the invention;

FIG. 29 shows illustrative features of a bubble bottle neck and cap, according to various embodiments of the invention; and

FIG. 30 shows an illustrative bubble bottle body with neck, cap and attached wand, according to various embodiments of the invention.

### DETAILED DESCRIPTION

Sustainable (reusable, refillable, and recyclable) bubble systems and methods according to embodiments of the present invention may comprise, for example, a bubble box/container/carton (recyclable), a refill bubble bag (recyclable), a bubble bottle (refillable and reusable, e.g., aluminum/steel; may be provided in the bubble box or separately), a plastic or aluminum bottle neck and plastic or aluminum bottle cap with bubble wand (either attached to the cap, integrated with the cap, non-attached or detachable), and bubble solution/concentrate (environmentally friendly). Embodiments of the invention may be referred to as a bubble box refill system/bubbles in a box/bubble solution or concentrate in a box/box of bubbles, etc.

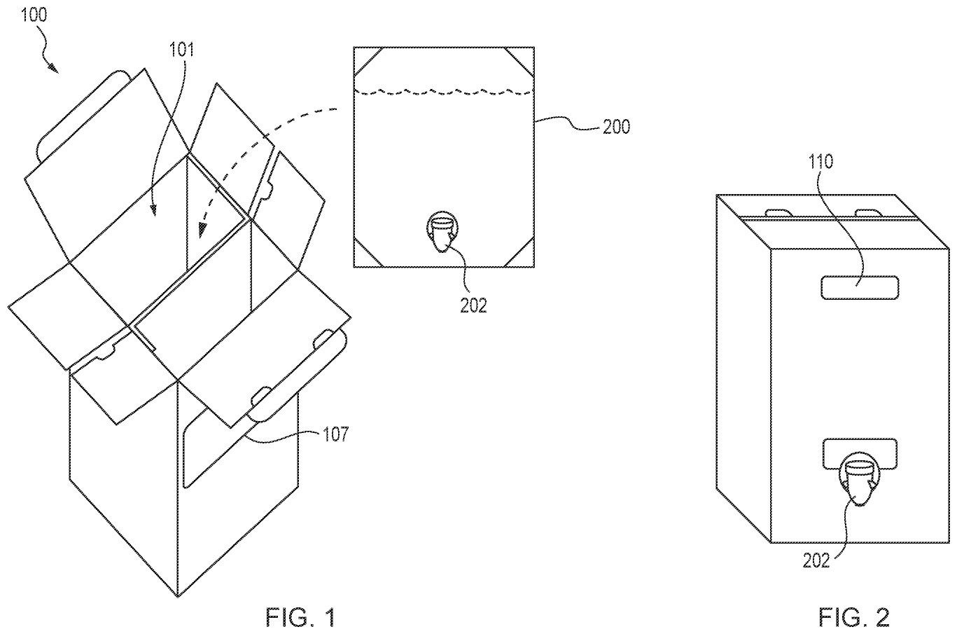

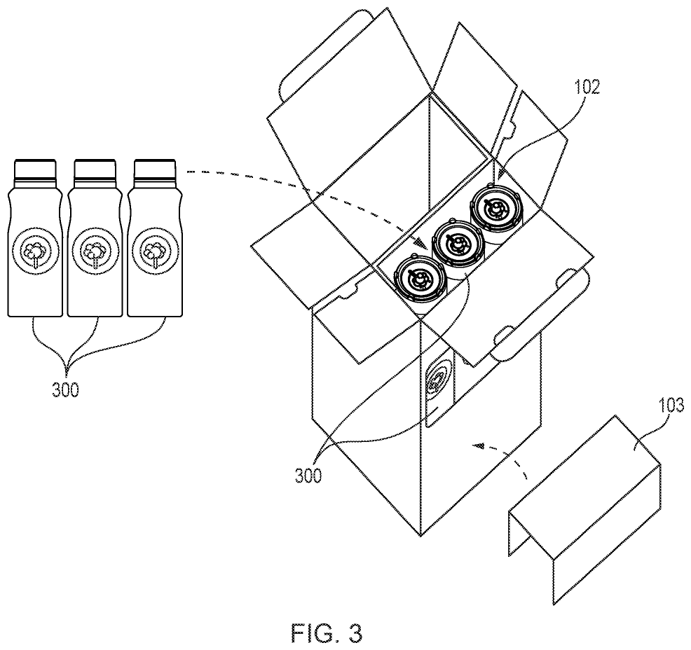

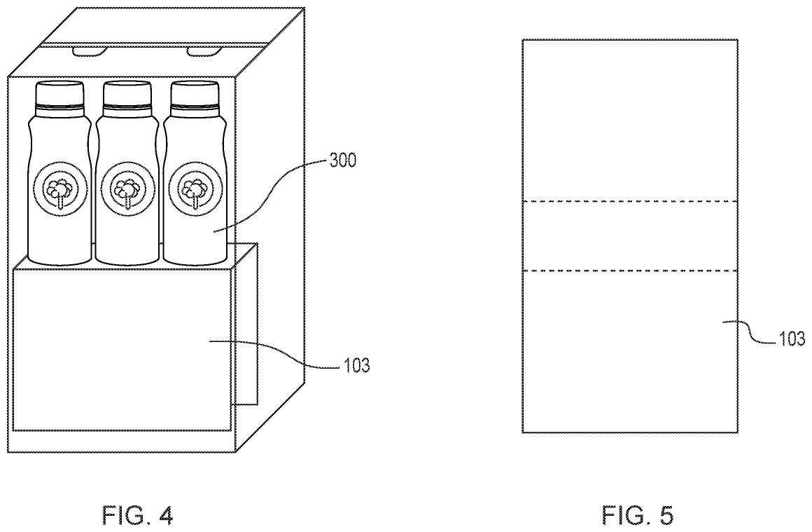

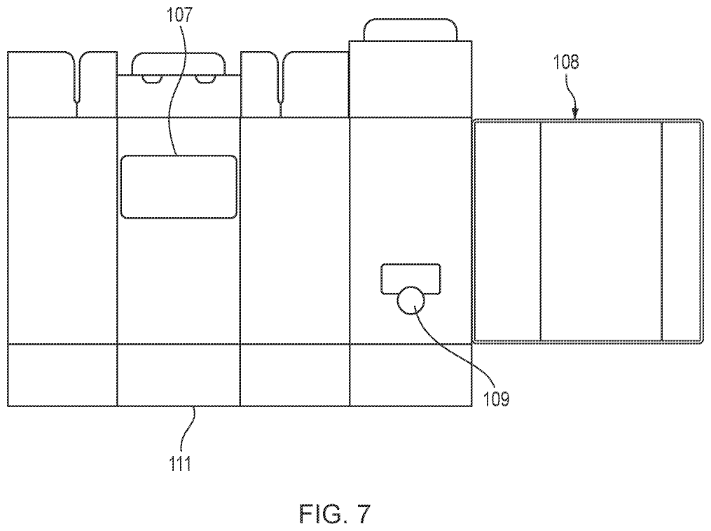

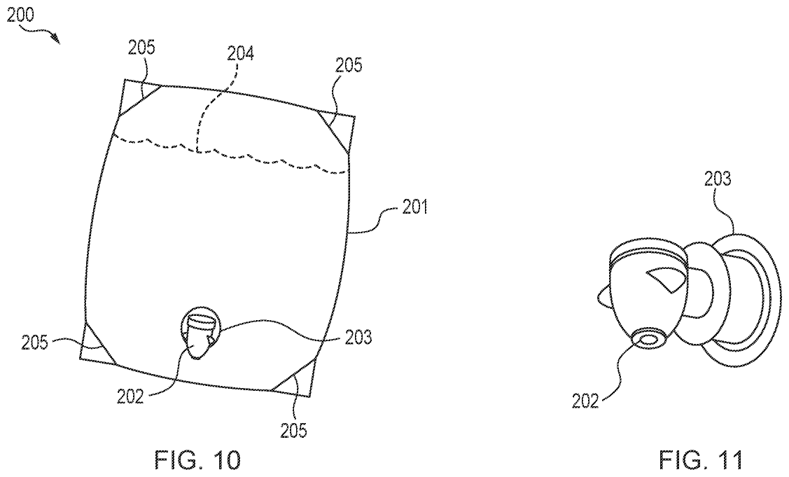

FIGS. 1-9 show an illustrative bubble box/container/carton 100 according to various embodiments of the invention. The bubble box 100 is preferably made of recyclable material (e.g., corrugated cardboard) and is configured as part of a reusable refill system as described herein (also referred to as a kit), in which it can function as a refill center/station. In some embodiments, the bubble box 100 includes two inner compartments 101, 102. With reference to FIGS. 1 and 2, one compartment of the bubble box 100 may comprise a storage compartment 101 configured to house/store a refill bubble bag 200. The refill bubble bag 200 (see also FIG. 10 and related description) may be formed from plastic, such as, but not limited to, linear low-density polyethylene (LLDPE) or other flexible material (suitable for forming a bag as opposed to a rigid plastic jug). In some embodiments, the refill bubble bag 200 may comprise more than one layer. For example, in some embodiments, the refill bubble bag 200 may have an inner ply and an outer ply with an O₂ barrier therebetween. The refill bubble bag 200 is configured to be filled with liquid bubble solution or concentrate. The volume (e.g., 1 L, 2 L, 3 L, 5 L, etc.) and dimensions of the bag 200 may be varied, depending on the desired size of the box 100 and other components of the system. As depicted in the upper right hand portion of FIG. 1, the refill bubble bag 200 may include a tap/spout 202 for dispensing the liquid bubble solution or concentrate therein. In some embodiments, the tap/spout 202 may be positioned on a lower center portion of the refill bubble bag 200 as shown. In other embodiments, the tap/spout 202 may be off-center, or may be provided on the left or right side of the refill bubble bag 200, as a matter of design choice. As depicted in FIG. 2, the refill bubble bag 200 may be housed/stored substantially inside the bubble box 100, with the tap/spout 202 extending out from the bubble box. In final operating position, the tap/spout 202 is positioned on an outside wall of the box 100, accessible to the user when the box 100 is closed. An opening in the box 100 may be provided to accommodate and support the tap/spout 202 extending therethrough. As shown in FIG. 7, in some embodiments, the box 100 may be perforated or otherwise cut so that the tap/spout opening 109 is initially closed, but can be opened after purchase, for example, by pressing in and pulling up a designated region of cardboard (pop and lift). A similar perforation/die cut portion in box 100 may be provided for a handle 110.

With further reference to FIG. 3, in some embodiments, the bubble box/container/carton 100 may also include a second storage compartment 102 configured to hold/store one or more refillable bubble bottles 300. In some embodiments, the bubble bottles 300 may comprise a metal material, such as, but not limited to, aluminum or steel. In other embodiments, the bubble bottles 300 may comprise a non-metal material, such as, but not limited to, one or more of plastic, wood, cardboard, paper, or glass. Three bubble bottles 300 are shown, each with a height approximately half that of the bubble box 100; however, different numbers and/or sizes of bubble bottles 300 may be provided as a matter of design choice (also depending on the size of the box 100). In some embodiments, there may be different sizes for the refillable bubble system. For example, in some embodiments, there may be three kit sizes provided: 2-bottle (41.81 fl oz), 3-bottle (80 fl oz), and 4-bottle (120 fl oz). As shown in FIGS. 3-5, in some embodiments, a bottle shelf insert 103 may be provided to support the bubble bottle(s) 300 from below. The bottle shelf insert 103 may be formed, for example, from a cardboard material with die-lines (indicated by dotted lines in FIG. 5) for folding. The shelf insert 103 is preferably configured to provide proper positioning and storage of bottles 300 in a window/opening 107 of the box, as described further below, and may be sized accordingly (e.g., depending on the respective heights of the bottles 300 and the box 100, and the position of the window 107 in the box 100, as described further below). In some embodiments, a bubble box/container/carton 100 may be provided with a refill bubble bag 200 therein, but without bubble bottles 300 and/or a bottle shelf insert 103 (e.g., to function as a replacement refill station when the cardboard box 100 is worn and/or the refill bag 200, which may be sealed in its compartment 101, is empty, but the bubble bottles 300 are still reusable and do not need to be replaced).

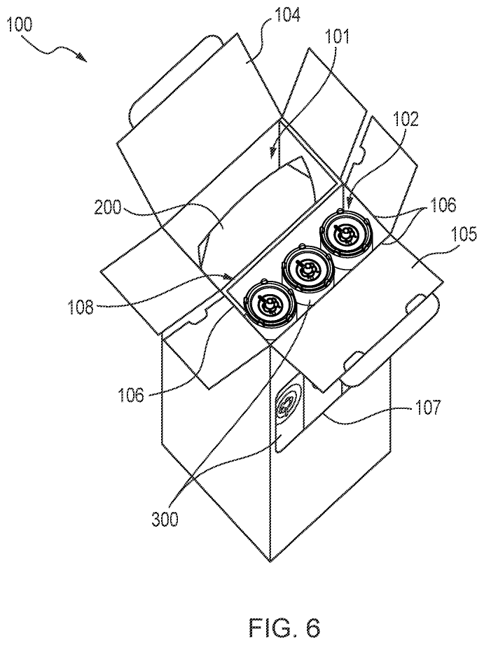

With further reference to FIG. 6, in some embodiments, the bubble box/container/carton 100 may have a top comprising dual opening flaps 104, 105, each flap comprising a longitudinal portion along a width of the box 100 and two side portions along a depth of the box 100. One flap 104 may provide access to the refill bag 200 (e.g., as described above, with tap/spout 202, filled with liquid bubble solution/concentrate 204) in its respective storage compartment 101. A second/separate flap 105 may provide access to the storage area 102 for bubble bottle(s) 300. Either/both of the flaps 104, 105 can comprise perforated/tear-away portions. For example, in some embodiments, the flap 105 to access the storage area 102 for the bubble bottles 300 may be perforated along edges 106, so that the longitudinal and side portions thereof can be torn away and removed to create easy access to the bottle storage area 102, while the flap 104 to access the refill bag 200 is non-perforated, and can remain in a closed position to secure the refill bag 200 in the bag storage area 101 of the box 100 during normal operation. In some embodiments, the flap 104 to access the refill bag 200 may be sealed in production (e.g., held closed using glue). In some embodiments, the longitudinal portions of flaps 104, 105 may include tuck tabs as shown. In some embodiments, the longitudinal portion of flap 104 may not include a tuck tab. The bottom flaps 111 of the bubble box/container/carton 100 (see FIG. 7) are preferably fully sealed and closed (e.g., secured with glue or other adhesive), so that neither of the compartments 101, 102 is accessible from the bottom of the box 100.

With further reference to FIG. 8, in some embodiments, a window/opening 107 may be provided (e.g., die-cut) in the bubble box/container/carton 100 to show the bubble bottles 300 in the storage area 102. This window/opening 107 can identify the front of the box/package 100 when on the retail shelf. As shown, the window/opening 107 is on an upper portion across a front width of the box 100. In other embodiments, the window/opening 107 may be positioned, shaped, and/or sized differently on the box 100, and/or one or more additional windows (on the front and/or sides of the box) may be provided. For example, in some embodiments, the window/opening 107 may wrap around, thus extending across the front width of the box and also along a portion (e.g., ⅜″) of one or both sides.

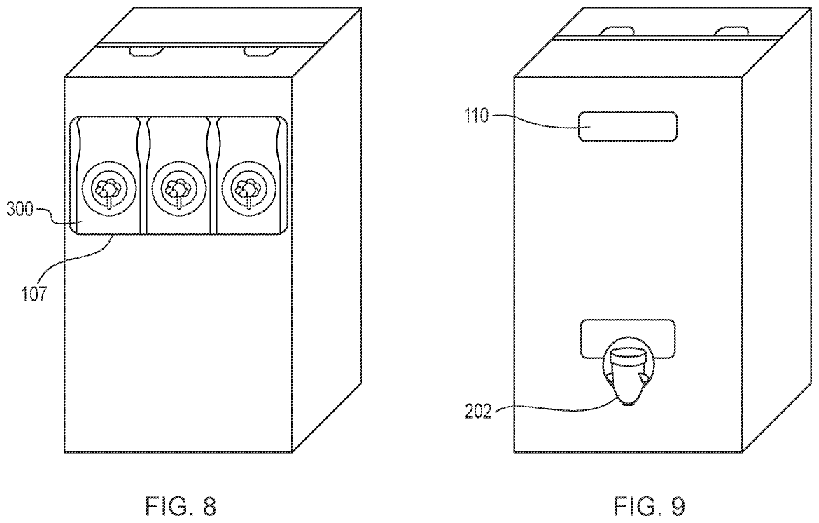

With further reference to FIGS. 6 and 7, in some embodiments, the bubble box/container/carton 100 may include a box partition 108, which creates two separate chambers (e.g., one chamber 101 in a rear section of the box 100, for a refill bag 200 with tap/spout 202 filled with liquid bubble solution/concentrate 204 and a second chamber 102 in a front section of the box 100 for bubble bottles 300, as shown in the perspective view of FIG. 6). As depicted in the schematic plan view of FIG. 7, in some embodiments, the bubble box/container/carton 100 may comprise a one piece box with partition design as shown, which features auto partition during box manufacture/assembly, and can speed up production by using less labor. This one piece box 100 also features no raw edges for the chamber 101 housing the refill bubble bag 200, which can prevent damage or tearing of the refill bubble bag 200 during storage and/or transit. Die cut portions for the retail front window 107 and the tap/spout access 109 on the reverse side of the box 100 are shown (cut out carry handle 110 illustrated in FIGS. 2 and 9 is not shown in FIG. 7, but may be optionally provided). These die cut portions may vary in exact size, shape, and placement, as a matter of design choice. The partition portion 108 of the one piece box 100 is marked with double lines in the schematic plan view of FIG. 7, and includes two folds therein. As shown in the assembled form in FIG. 6, the partition 108 extends along one side of the first compartment 101, bends and runs the length between the two compartments 101, 102, and then bends and extends along a portion of the opposite side of the second compartment 102.

With further reference to FIGS. 8 and 9, in some embodiments, the front and rear of the bubble box/container/carton 100 can have two separate features/elements/functions. For example, as shown at FIG. 8, a retail front side of the bubble box 100 can show bottle storage as seen by the consumer at retail (e.g., window/opening 107 showing bottles 300). As shown at FIG. 9, the opposite (back) side of the bubble box 100 can serve as the main functioning panel during consumer use of the system (retail back side becomes consumer-use front side). Positioning the tap/spout 202 on the back side can eliminate raw edges and tearing of the refill bubble bag 200, as shown in FIG. 7. In some embodiments, a carry handle 110 (e.g., a perforated section configured to provide an opening in an upper portion of the box 100) may be provided on this consumer-use front side, to carry/transport the system (e.g., for easy portability). The consumer-use front side also features the refill bubble solution tap/spout 202, which can include an auto shut-off valve.

With reference to FIGS. 10 and 11, illustrative embodiments of the refill bubble bag 200 are described in further detail. As shown in FIG. 10, the refill bag 200 is configured to be filled with liquid bubble solution or concentrate 204. The refill bag 200 stores the liquid bubble solution or concentrate 204, and dispenses it, for example, via a tap/spout 202. The body 201 of the refill bag 200 may comprise, for example, LLDPE or other plastic bag material suitable for storing liquid. The auto shut-off tap/spout 202 may comprise, for example, polypropylene or other suitable plastic material. The fitment 203 may also comprise, for example, polypropylene or other suitable plastic material. In some embodiments, the refill bag 200 has four delta seals 205, each delta seal comprising a heat seal in one of the four corners of the bag 200, sealing off the respective corner and preventing liquid from entering. The delta seals 205 can improve the amount of solution/concentrate 204 dispensed through the tap/spout 202 by limiting the amount of solution/concentrate 204 that would normally (without seals 205) be trapped in the corners of the refill bag 202 making it difficult for the end user to dispense all or most of the liquid solution or concentrate 204. As shown in FIG. 6, the refill bag 200 stores and functions inside the box 100 within its own partitioned chamber 101, separate from the bottles 300. FIG. 11 shows a detail view of an illustrative tap/spout 202 with fitment 203 and auto shut-off valve for controlled dispensing, according to some embodiments.

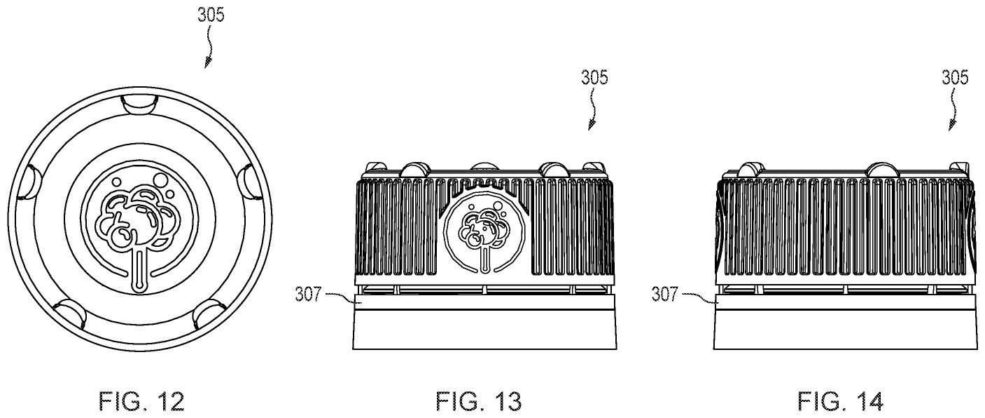

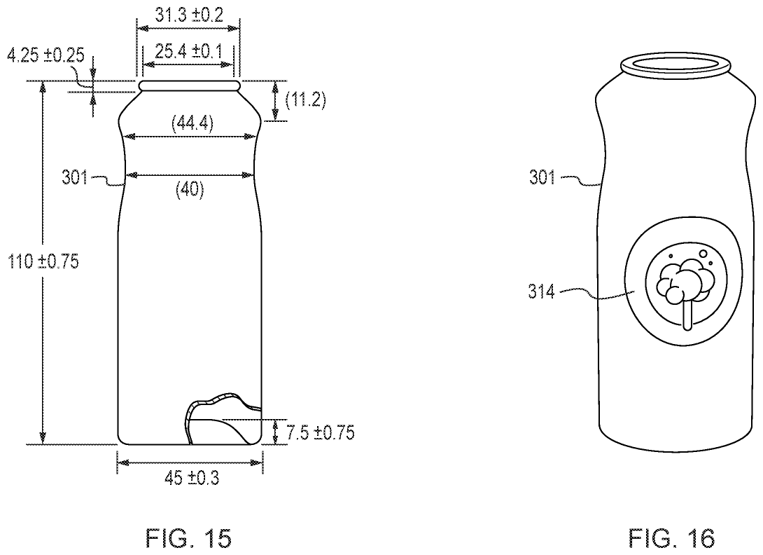

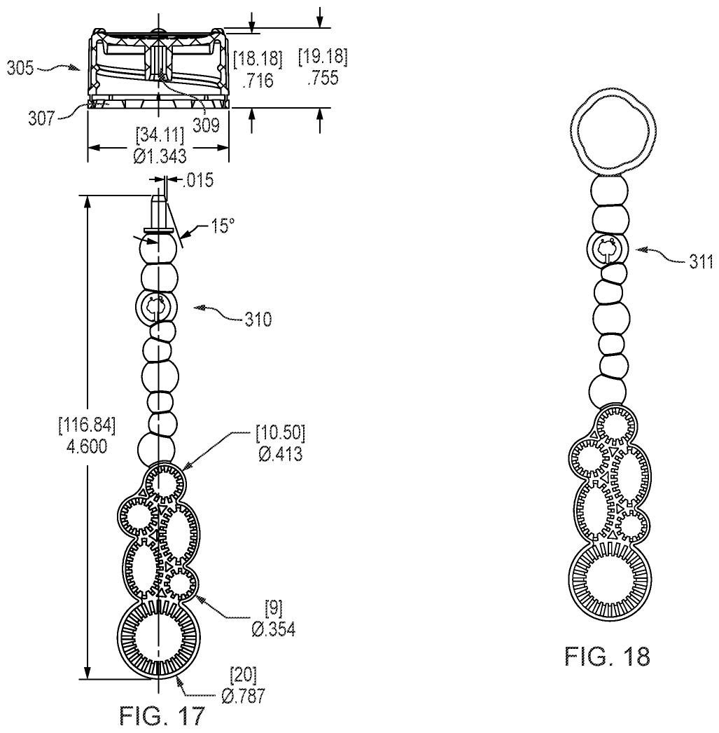

With reference to FIGS. 12-30, illustrative features of various embodiments of the bubble bottles 300 are described in further detail. As shown in FIG. 15, embodiments of a bubble bottle 300 may comprise, for example, an aluminum bubble bottle body 301 configured to be filled with liquid bubble solution/concentrate 204. As shown in FIGS. 12-14, (which show top, front, and back views, respectively) in some embodiments, the bubble bottle 300 may be sealed with a plastic or aluminum (or other suitable material, metal or non-metal) screw cap 305 having a tamper-evident ring 307. When cap 305 is unscrewed for a first use, tamper-evident ring 307 is detached from the main body of cap 305. The tamper-evident screw cap closure can eliminate the need for other tamper-evident features, such as heat seal foils covering the bottle opening and/or plastic shrink wrap on the outside of the cap. As shown in FIGS. 17 and 18, the tamper-evident screw cap 305 may be configured to have a bubble wand 310 attached thereto (e.g., to an inside surface thereof as shown at 309), or alternatively a non-attached bubble wand 311 may be provided as shown in FIG. 18. The wand 310 may be integrated with the cap 305 or may be detachable. Illustrative dimensions (in mm) are marked; however, the exact dimensions of the cap 305 and wand 310 may vary as a matter of design choice. As shown in FIG. 16, the bubble bottle body 301 may include printed graphics 314 on an outer surface thereof (e.g., to identify the system at least in part when viewed through a window in the box as described above). In some embodiments, the graphics 314 may be printed with a “soft touch” finish for better grip. As shown at FIG. 15, an aluminum bubble bottle according to embodiments of the invention may feature a contoured shape body 301 for better grip. The curve in the bottle body 301 can serve as a handle and a stop grip. Illustrative dimensions (in mm) are marked; however, the exact size and contour dimensions of the bottle body 301 may vary as a matter of design choice. In some embodiments, the bubble bottle body 301 may comprise, for example, a refillable and reusable bottle for liquid soap bubbles/concentrate. In some embodiments, the bubble bottle body 301 may comprise, for example, a dishwasher-safe bottle for liquid soap bubbles/concentrate. Although the embodiments described herein refer to primarily to aluminum bubble bottles, in other embodiments other metals (e.g., steel) or non-metal (e.g., corrugated, plastic, glass, paper, etc.) materials, alone or in combination with metal or non-metal materials, may be used to form the body 301 of the bubble bottles 300.

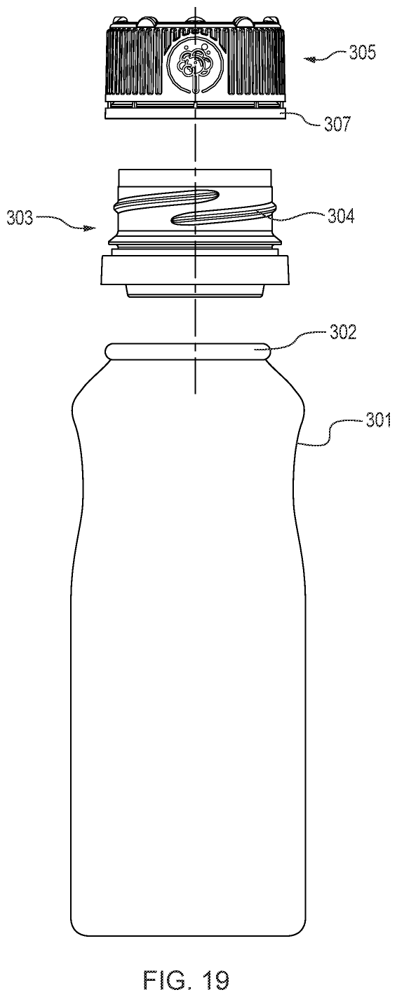

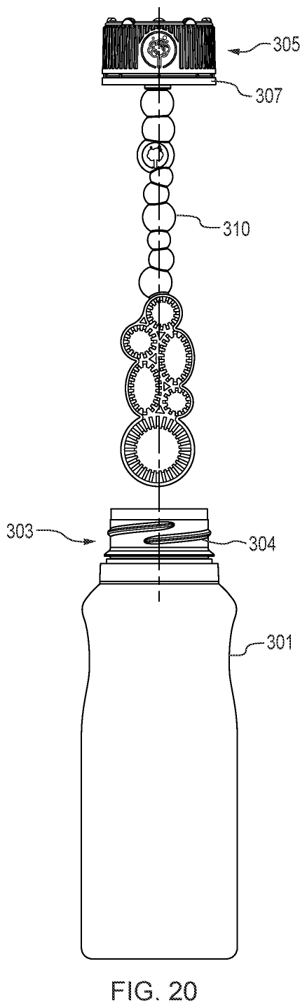

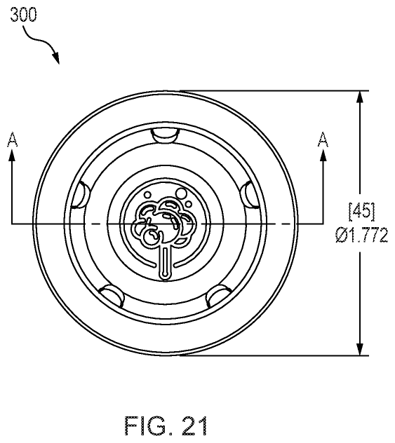

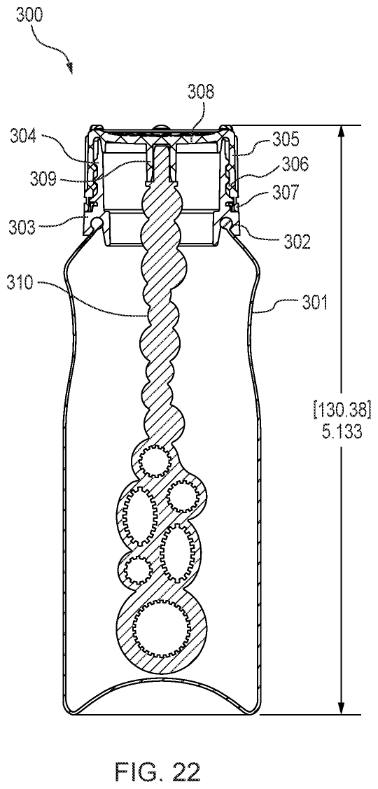

With reference to FIGS. 19-22, additional illustrative features of various embodiments of the bubble bottles 300 are described in further detail. FIG. 20 shows an illustrative plastic bottle neck 303 and plastic bottle cap 305 with attached bubble wand 310, according to various embodiments. As shown at FIG. 19, a plastic cap 305 with tamper-evident ring 307 may be provided, which is configured to screw onto a plastic bottle neck 303 having a screw thread 304 on an external surface thereof. The plastic bottle neck 303 is configured to be press-fit/snapped onto a rolled edge 302 of an aluminum bubble bottle body 301 (also referred to as the bottle's “machine curl”). Aluminum bottles are typically configured for aerosol use, not for use with a plastic neck 303 and screw cap 305 as described herein. As shown at FIG. 20, the screw on plastic cap 305 with tamper-evident ring 307 may have an attached bubble wand 310 on the underside of an upper surface thereof. The plastic bottle neck 303 with screw threads 304 press-fits/snaps to the aluminum bottle body 301 as shown, and is thus positioned to receive the cap 305. As shown, for example, at FIG. 17, in some embodiments, the wand 310 is configured to snap into the cap 305 via a structure 309, so it is secured thereto. As shown in the top view of FIG. 21, and in the section view of FIG. 22 (taken along A-A of FIG. 21), the plastic cap 305 with tamper-evident ring 307 and attached bubble wand 310 then screws onto the plastic neck 303 that is press-fit/snapped to the bubble bottle's rolled edge/curl 302.

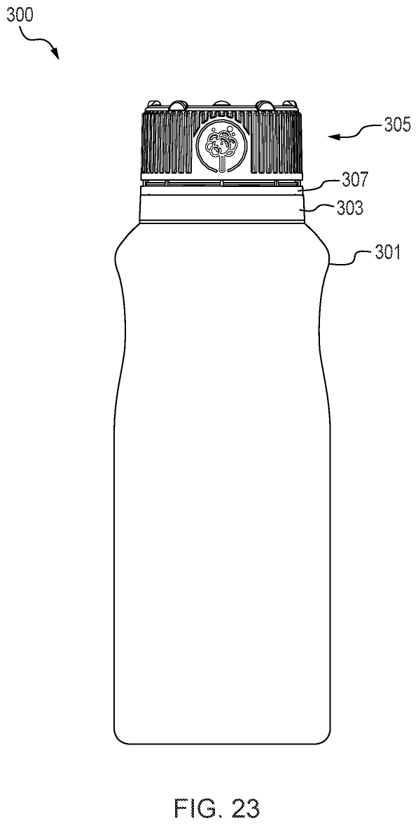

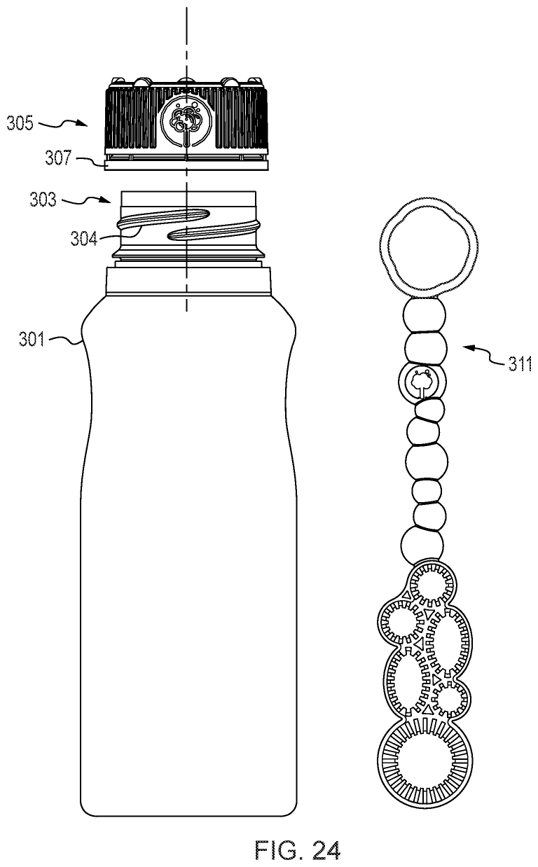

FIG. 23 shows an illustrative bubble bottle 300 having an aluminum bottle body 301, a plastic bottle neck 303, and a plastic bottle cap 305, according to various embodiments. As also shown in the exploded view of FIG. 19, a plastic cap 305 with tamper-evident ring 307 can be provided, which screws onto a screw thread 304 on a plastic neck 303 that press-fits/snaps onto a round/rolled edge/curl 302 of the bottle body 301. An attached bubble wand 310 can be provided as shown, for example, in FIGS. 20-22. Alternatively, as shown in FIG. 24, a non-attached bubble wand 311 can be provided separate from (not configured to be attached/secured to) the cap 305.

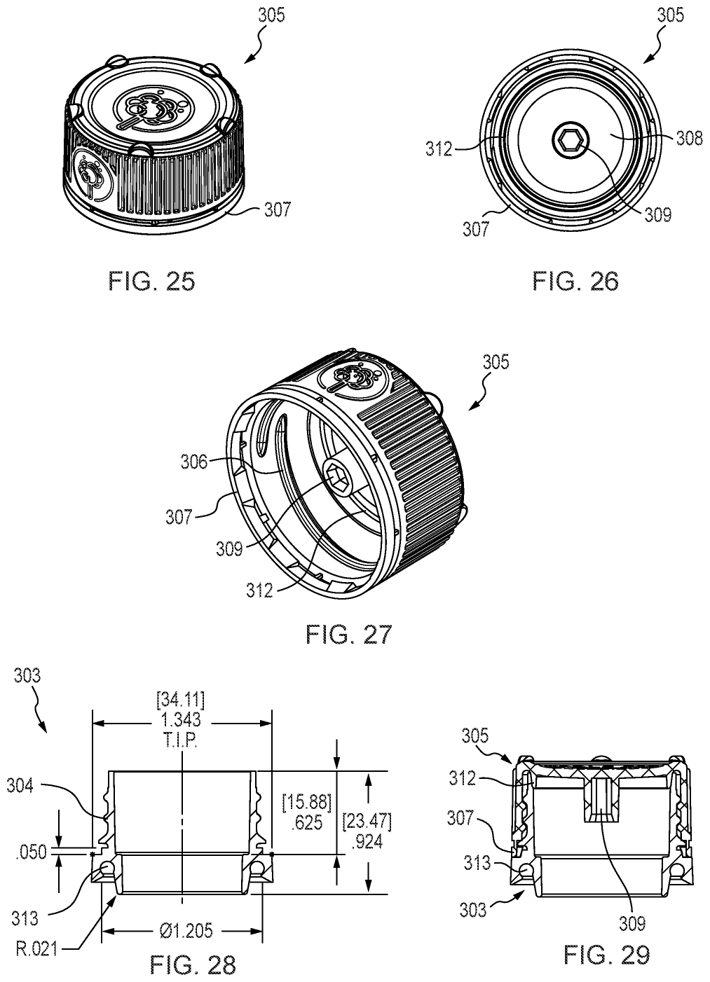

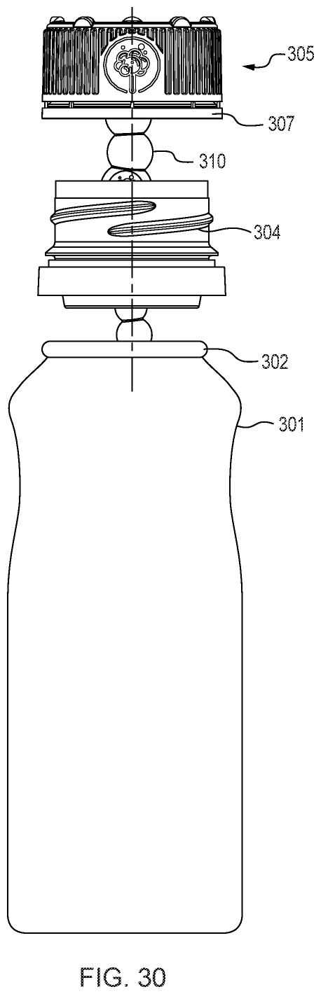

FIGS. 25-27 show an illustrative plastic bottle cap 305 with internal screw thread 306, inner ring seal 312, and outer tamper-evident ring 307. As shown in FIGS. 26, 27, and 29, a structure 309 (e.g., a socket) can be provided on an underside surface 308 of cap 305 for an attachable bubble wand 310 to be snapped/press-fit into. Structure 309, which may be integrally formed with the cap 305, protrudes from surface 308 and is configured to secure wand 310 therein. An inner ring seal 312 can also be provided on surface 308 to prevent leaking between the cap 305 and the neck 303. As shown in FIGS. 28 and 29, the plastic bottle neck 303 can also be configured to have a press-fit/snap-fit seal at 313 to the rolled edge 302 of the bottle body 301. Thus, leaking can be prevented between the three components (cap 305, neck 303, and bottle body 301). FIG. 30 shows an exploded view of a complete bubble bottle 300 according to some embodiments, including an aluminum bottle body 301 with rolled edge/curl 302, a plastic bottle neck 303 with screw thread 304, and a plastic cap 305 with tamper-evident ring 307 and attached bubble wand 310. The cap 305, wand 310 (or 311), and neck 303 may each be made of a plastic material. The plastic material for each of the components may be the same or different, and may comprise, for example, polypropylene (PP), co-polymer polypropylene (COPP), low-density polypropylene (LDPP), low-density polyethylene (LDPE), high-density polyethylene (HDPE), or a combination thereof or other hybrid plastic material. In some embodiments, the cap 305 material may comprise, for example, low-density polyethylene (LDPE). The wand 310/311 material may comprise, for example, polypropylene (PP). The neck 303 material may comprise, for example, co-polymer polypropylene (COPP). In other embodiments, however, other plastic materials (known or to be developed) may be used for these components.

The bubble solution 204 may be provided at the strength to be used by the consumer (1×), or as a concentrate (e.g., 5×, 10×, 20×, etc.) to which a predetermined volume of water is to be added prior to use. The bubble solution/concentrate 204 according to embodiments of the present invention is environmentally friendly. For example, the bubble solution/concentrate 204 may be paraben free, formaldehyde donor free, NPE (nonylphenol ethoxylate) free, sulfate free, phthalate free, and/or DEA (diethanolamine) free. Preferably, all ingredients of the bubble solution/concentrate 204 are on the EPA's Safer Chemical Ingredients List. Preferably, the bubble solution/concentrate 204 is non-toxic, and does not contain chemicals such as DMDM (1,3-dimethylol-5,5-dimethyl) hydantoin.

While there have been shown and described fundamental novel features of the invention as applied to the preferred and illustrative embodiments thereof, it will be understood that omissions and substitutions and changes in the form and details of the disclosed invention may be made by those skilled in the art without departing from the spirit of the invention. Moreover, as is readily apparent, numerous modifications and changes may readily occur to those skilled in the art. For example, various features and structures of the different embodiments discussed herein may be combined and interchanged. Hence, it is not desired to limit the invention to the exact construction and operation shown and described and, accordingly, all suitable modification equivalents may be resorted to falling within the scope of the invention as claimed. It is the intention, therefore, to be limited only as indicated by the scope of the claims appended hereto.

What is claimed is:

1. A sustainable refill bubble system, comprising:
a box having two compartments therein, a first compartment located in a rear section of the box and a second compartment located in a front section of the box;
a refill bag, including a dispensing tap, configured to fit inside the first compartment of the box;
two or more bubble bottles, having aluminum bodies, configured to fit inside the second compartment of the box; and
a liquid bubble solution or concentrate provided inside the refill bag, wherein the liquid bubble solution or concentrate is environmentally friendly and non-toxic, and the liquid bubble solution or concentrate is paraben free, formaldehyde donor free, NPE (nonylphenol ethoxylate) free, sulfate free, phthalate free, and DEA (diethanolamine) free,
wherein a front side of the box includes a window for viewing the two or more bubble bottles on a retail shelf, the two or more bubble bottles positioned upright in the box with at least a portion of the aluminum bodies visible through the window.

2. The system of claim 1, wherein at least one of the box, the refill bag, and the two or more bubble bottles comprise a recyclable material.

3. The system of claim 1, wherein the box comprises a corrugated cardboard material.

4. The system of claim 1, wherein the box is formed from a single piece of material, said piece including a partition section for separating the two compartments.

5. (canceled)

6. The system of claim 1, wherein a back side of the box includes a first perforated portion configured to provide a carry handle.

7. The system of claim 1, wherein a back side of the box includes a second perforated portion configured to provide an opening for the tap.

8. The system of claim 1, wherein each compartment of the box has a top flap.

9. The system of claim 1, wherein the tap has an automatic shut-off valve for controlled dispensing.

10. (canceled)

11. The system of claim 1, wherein the two or more bubble bottles include a plastic or aluminum bottle neck press-fit or snap-fit to a rolled edge/curl of the aluminum body.

12. The system of claim 11, wherein the two or more bubble bottles include a plastic or aluminum screw cap with tamper-evident ring configured to screw onto the plastic or aluminum bottle neck.

13. The system of claim 12, wherein the two or more bubble bottles include a plastic bubble wand secured to an inner surface of the screw cap.

14. The system of claim 12, wherein the two or more bubble bottles include a plastic bubble wand not attached to the screw cap.

15-16. (canceled)

17. The system of claim 1, wherein the refill bag has a delta seal on one or more corners thereof.

18. A method of reducing waste associated with bubble blowing, comprising:
providing a bubble box comprising a single piece of corrugated cardboard, the box having two compartments therein, separated by a partition;
providing a refill bubble bag configured to fit inside a first compartment spanning a back side of the box, the bag containing an environmentally friendly and non-toxic liquid bubble solution or concentrate that is paraben free, formaldehyde donor free, NPE (nonylphenol ethoxylate) free, sulfate free, phthalate free, and DBA (diethanolamine) free; and
providing two or more refillable, reusable, and recyclable bubble bottles, having aluminum bodies, configured to fit inside a second compartment spanning a front side of the box,
wherein the bag includes a tap accessible from outside the box for dispensing the liquid bubble solution or concentrate into the two or more bubble bottles, and
wherein the front side of the box includes a window for viewing the two or more bubble bottles on a retail shelf, the two or more bubble bottles positioned upright in the box with at least a portion of the aluminum bodies visible through the window.

19. (canceled)

20. The system of claim 1, further comprising a bottle shelf insert for positioning the two or more bubble bottles in the window, the insert comprising a substantially rectangular piece of cardboard material.

21. A sustainable refill bubble system, comprising:
a box having two compartments therein, a first compartment located in a rear section of the box and a second compartment located in a front section of the box;
a refill bag configured to fit inside the first compartment of the box;
two or more bubble bottles configured to fit inside the second compartment of the box; and
a liquid bubble solution or concentrate provided inside the refill bag,
wherein the liquid bubble solution or concentrate is environmentally friendly and non-toxic, and the liquid bubble solution or concentrate is paraben free, formaldehyde donor free, NPE (nonylphenol ethoxylate) free, sulfate free, phthalate free, and DEA (diethanolamine) free,
wherein the refill bag includes a tap for dispensing the liquid bubble solution or concentrate,
wherein the two or more bubble bottles each have an aluminum body, and include a plastic bottleneck press-fit or snap-fit to a rolled edge/curl of the aluminum body; a plastic screw cap with tamper-evident ring configured to screw onto the plastic bottle neck; and a plastic bubble wand secured to an inner surface of the screw cap, and
wherein the front side of the box includes a window for viewing the two or more bubble bottles on a retail shelf, the two or more bubble bottles positioned upright in the box with at least a portion of the aluminum bodies visible through the window.

22. The system of claim 21, wherein the box is formed from a single piece of material, said piece including a partition section for separating the two compartments.

23. The system of claim 21, wherein the refill bag has a delta seal on one or more corners thereof.

24. The system of claim 21, further comprising a bottle shelf insert for positioning the two or more bubble bottles in the window, the insert comprising a substantially rectangular piece of cardboard material.
